(19) United States
(12) Patent Application Publication
(10) Pub. No.: US 2025/0232914 A1
(43) Pub. Date: Jul. 17, 2025

(54) MULTILAYERED CAPACITOR

(71) Applicant: SAMSUNG ELECTRO-MECHANICS CO., LTD., Suwon-si (KR)

(72) Inventors: Munseong JEONG, Suwon-si (KR); Jungmin KIM, Suwon-si (KR); Jinkyung PARK, Suwon-si (KR); Hyunjun HWANG, Suwon-si (KR); Changsoo JANG, Suwon-si (KR); Won Seok JANG, Suwon-si (KR); Nayoung KIM, Suwon-si (KR)

(73) Assignee: SAMSUNG ELECTRO-MECHANICS CO., LTD., Suwon-si (KR)

(21) Appl. No.: 18/743,377

(22) Filed: Jun. 14, 2024

(30) Foreign Application Priority Data
Jan. 16, 2024 (KR) 10-2024-0006949

(51) Int. Cl. H01G 4/008; H01G 4/12; H01G 4/30

(52) U.S. Cl. CPC H01G 4/0085; H01G 4/1227; H01G 4/1245; H01G 4/30

(57) ABSTRACT

A multilayered capacitor may include a capacitor body including a dielectric layer and an internal electrode, and an external electrode outside the capacitor body, wherein the internal electrode includes zirconium (Zr), an average content of zirconium (Zr) for the internal electrode is greater than or equal to about 0.0005 mol % and less than about 5.0 mol %, the dielectric layer includes a plurality of dielectric grains, at least one of the plurality of dielectric grains has a core-shell structure, and the core, the shell, or both include zirconium (Zr).

### CROSS-REFERENCE TO RELATED APPLICATION

This application claims priority to and the benefit of Korean Patent Application No. 10-2024-0006949 filed in the Korean Intellectual Property Office on Jan. 16, 2024, the entire contents of which are incorporated herein by reference.

### BACKGROUND

The present disclosure relates to a multilayered capacitor.

### TECHNICAL FIELD

Recently, as multi-functionalization and miniaturization of electronic devices have been rapidly progressing, miniaturization and performance improvement of electronic components have also been progressing at a rapid pace. Further, the demand for high reliability of electric devices for use in automobiles, network equipment, or the like and electronic components for use in industries has also been increasing significantly.

In order to meet such market demands, competition for technology development of passive components such as inductors, capacitors, or resistors has been accelerating. In particular, great effort has been required to dominate the market by developing various multilayer ceramic capacitor (MLCC) products whose applications and usage as passive components have been continuously increasing.

In addition, a multilayered capacitor is manufactured by stacking dielectric layers and internal electrodes, and is used in various electronic devices such as mobile phones, laptops, and LCD TVs.

With recent technological advancements, multilayered capacitors are required to be miniaturized and have high capacities. To this end, technologies have been developed to increase an effective electrode area by increasing the connectivity of the internal electrodes in contact with the dielectric layer, or to atomize the dielectric material and internal electrode material.

However, if the materials are atomized, a melting point thereof decreases, which may lower a heat shrinkage temperature of the materials. In particular, because a metal material included in the internal electrodes has a higher heat shrinkage temperature decrease rate than a ceramic material included in the dielectric layer, the dielectric layer and the internal electrodes may have a larger heat shrinkage temperature difference.

The larger heat shrinkage temperature difference between the dielectric layer and the internal electrodes, the more possibly their electrode connectivity may be deteriorated after sintering the dielectric layer and the internal electrodes, resultantly deteriorating electrical capacitance and reliability of the multilayered capacitors.

Currently, in order to reduce the heat shrinkage temperature difference between the dielectric layer and the internal electrodes, a method of adding a nano-sized barium titanite (BaTiO₃) co-material, when manufacturing the internal electrodes, is being adopted.

However, if a content of the barium titanite co-material is increased, because layer density of the internal electrodes decreases, the co-material diffused into the dielectric layer may increase a thickness of the dielectric layer, causing a side effect of deteriorating capacitance of the capacitors. Accordingly, it is necessary to develop a new co-material causing no side effect, even if diffused to the dielectric layer, as well as having high thermal stability.

### SUMMARY OF THE INVENTION

One aspect of the embodiment provides a multilayered capacitor with improved electrode connectivity and excellent reliability.

However, the problems that the embodiments seek to solve are not limited to the above-described problems and can be expanded in various ways within the scope of the technical ideas included in the embodiments.

A multilayered capacitor according to an embodiment includes a capacitor body including a dielectric layer and an internal electrode, and an external electrode outside the capacitor body, wherein the internal electrode includes zirconium (Zr), an average content of zirconium (Zr) for the internal electrode is greater than or equal to about 0.0005 mol % and less than about 5.0 mol %, the dielectric layer includes a plurality of dielectric grains, at least one of the plurality of dielectric grains has a core-shell structure, and the core, the shell, or both include zirconium (Zr).

The internal electrode may additionally include a conductive metal.

The dielectric grains include a main component and a subcomponent,

The main component may include BaₘTiO₃ (0.995≤m≤1.010), (Ba₁₋ₓCaₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x≤0.10), (Ba₁₋ₓCaₓ)ₘ(Ti_{1-y}Sn_{y})O₃ (0.995≤m≤1.010, 0≤x≤0.10, 0<y≤0.20), or a combination thereof.

The subcomponent may include zirconium (Zr), manganese (Mn), chromium (Cr), silicon (Si), aluminum (Al), magnesium (Mg), tin (Sn), antimony (Sb), hafnium (Hf), and germanium (Ge), gallium (Ga), indium (In), lanthanum (La), yttrium (Y), actinium (Ac), cerium (Ce), praseodymium (Pr), neodymium (Nd), promethium (Pm), samarium (Sm), europium (Eu), gadolinium (Gd), Terbium (Tb), dysprosium (Dy), holmium (Ho), erbium (Er), thulium (Tm), ytterbium (Yb), lutetium (Lu), or a combination thereof.

An average content of zirconium (Zr) for a total internal electrode may be in a range from about 0.001 mol % to about 1.0 mol %.

An average content of zirconium (Zr) included in an entirety of the shell may be greater than an average content of zirconium (Zr) included in the core for a total core.

An average content of zirconium (Zr) included in an entirety of the shell may be in a range from about 0.001 mol % to about 10.0 mol %.

An average content of zirconium (Zr) included in an entirety of the core may be in a range from about 0 mol % to about 2.0 mol %.

An average thickness of the dielectric layer may be in a range from about 0.1 μm to about 5 μm.

An average thickness of the internal electrode may be in a range from about 0.1 μm to about 2 μm.

A multilayered capacitor according to another embodiment includes a capacitor body including a dielectric layer and an internal electrode, and an external electrode outside the capacitor body, wherein the internal electrode includes a conductive metal and zirconium (Zr), the dielectric layer includes a plurality of dielectric grain, at least one of the plurality of dielectric grains has a core-shell structure, and the core, the shell, or both include zirconium (Zr), an average content of Zr in the core is less than about 1 mol %, and an average content of Zr in the shell is in a range from about 0.001 mol % to about 10 mol %.

A multilayered capacitor according to another embodiment includes an internal electrode comprising zirconium (Zr) and a conductive metal, wherein an average content of Zr in the internal electrode is in a range from about 0.0005 mol % to about 5.0 mol %; and a dielectric layer comprising at least one dielectric grain having a core-shell structure, wherein core of the core-shell structure has an average Zr content of less than 1 mol %, and shell of the core-shell structure has an average Zr content in a range from about 0.001 mol % to about 10 mol %.

The multilayered capacitor according to the embodiment has the advantage of improved electrode connectivity and excellent reliability.

However, the various and beneficial advantages and effects of the present invention are not limited to the above-described descriptions, and may be more easily understood in the process of explaining specific embodiments of the present invention.

### BRIEF DESCRIPTION OF THE DRAWINGS

FIG. 1 is a perspective view showing a multilayered capacitor according to an embodiment.

FIG. 2 is a cross-sectional view of the multilayered capacitor taken along line I-I′ of FIG. 1.

FIG. 3 is an exploded perspective view showing the stacked structure of internal electrode layers in the capacitor body of FIG. 1.

FIG. 4 is a scanning electron microscope (SEM) image of a portion of the cross section of a multilayered capacitor according to an embodiment.

FIG. 5 is an image showing a portion of the SEM image of FIG. 4 mapped for the Zr component.

FIG. 6 is a TEM (Transmission Electron Microscope) image of a portion of the cross section of a multilayered capacitor according to an embodiment.

FIG. 7 is an image showing a portion of the TEM image of FIG. 6 mapped for the Zr component.

### DETAILED DESCRIPTION OF THE EMBODIMENTS

Hereinafter, exemplary embodiments of the present invention will be described in detail with reference to the accompanying drawings such that those skilled in the art can easily implement them. The drawings and description are to be regarded as illustrative in nature and not restrictive. Like reference numerals designate like elements throughout the specification. Further, the accompanying drawings are provided for helping to easily understand exemplary embodiments disclosed in the present specification, and the technical spirit disclosed in the present specification is not limited by the accompanying drawings, and it will be appreciated that the present invention includes all of the modifications, equivalent matters, and substitutes included in the spirit and the technical scope of the present invention.

Terms including an ordinary number, such as first and second, are used for describing various constituent elements, but the constituent elements are not limited by the terms. The terms are used only to discriminate one constituent element from another constituent element.

When a constituent element is referred to as being “connected” or “coupled” to another constituent element, it will be appreciated that it may be directly connected or coupled to the other constituent element, or face the other constituent element, or intervening other constituent elements may be present. In contrast, when a constituent element is referred to as being “directly connected” or “directly coupled” to another constituent element, it will be appreciated that there are no intervening other constituent elements present.

In the present specification, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Accordingly, unless explicitly described to the contrary, the word “comprise,” and variations such as “comprises” or “comprising,” will be understood to imply the inclusion of stated elements but not the exclusion of any other elements.

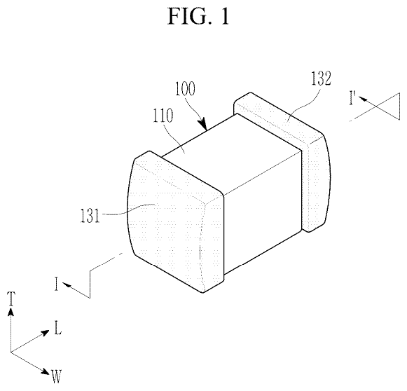

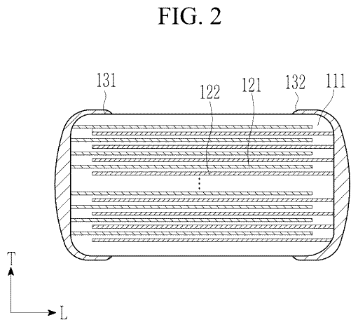

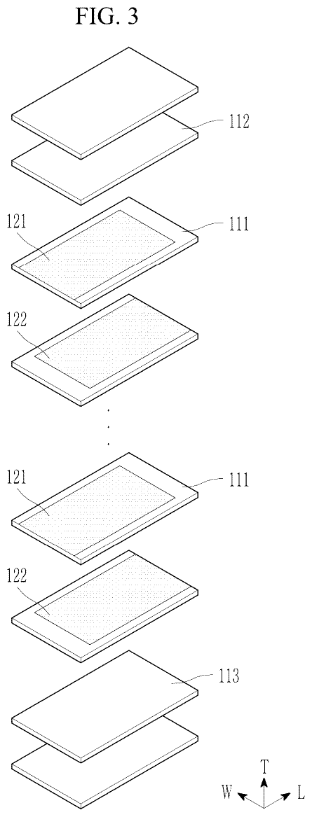

FIG. 1 is a perspective view showing a multilayered capacitor 100 according to an embodiment, FIG. 2 is a cross-sectional view of the multilayered capacitor 100 taken along line I-I′ of FIG. 1, and FIG. 3 is an exploded perspective view showing the stacked structure of internal electrodes in the capacitor body 110 of FIG. 1.

To clearly describe the present embodiment, directions are defined as follow: the L axis, the W axis, and the T axis shown in the drawings represent the longitudinal direction, width direction, and thickness direction of the capacitor body 110, respectively. Herein, the thickness direction (T-axis direction) may be a direction perpendicular to wide surfaces (main surfaces) of sheet-shaped constituent elements, and may be used, for example, as the same concept as the stacking direction in which dielectric layers 111 are stacked. The longitudinal direction (L-axis direction) may be a direction extending in parallel with the wide surfaces (main surfaces) of the sheet-shaped constituent elements and be a direction appropriately perpendicular to the thickness direction (T-axis direction), and may be, for example, a direction in which a first external electrode 131 and a second external electrode 132 are positioned on both sides. The width direction (W-axis direction) may be a direction extending in parallel with the wide surfaces (main surfaces) of the sheet-shaped constituent elements and be a direction appropriately perpendicular to the thickness direction (T-axis direction) and the longitudinal direction (L-axis direction), and the lengths of the sheet-shaped constituent elements in the longitudinal direction (L-axis direction) may be longer than their lengths in the width direction (W-axis direction).

Referring to FIGS. 1 to 3, the multilayered capacitor 100 according to the embodiment may include the capacitor body 110, and the first external electrode 131 and the second external electrode 132 that are disposed on both ends of the capacitor body 110 facing each other in the longitudinal direction (L-axis direction).

The capacitor body 110 may have, for example, an approximate hexahedral shape.

In the present embodiment, for ease of explanation, in the capacitor body 110, two surfaces facing each other in the thickness direction (T-axis direction) are defined as a first surface and a second surface, and two surfaces that are coupled to the first surface and the second surface and face each other in the longitudinal direction (L-axis direction) are defined as a third surface and a fourth surface, and two surfaces that are coupled to the first surface and the second surface, are coupled to the third surface and the fourth surface, and face each other in the width direction (W-axis direction) are defined as a fifth surface and a sixth surface.

As an example, the first surface which is the lower surface may be a surface oriented to the mounting direction. Further, the first surface to the sixth surface may be flat; however, the present exemplary embodiment is not limited thereto, and for example, the first surface to the sixth surface may be curved surfaces with convex center portions, and the border of each surface, i.e., the edge may be rounded.

The shape and dimensions of the capacitor body 110 and the number of dielectric layers 111 that are stacked are not limited to those shown in the drawings of the present embodiment.

The capacitor body 110 is formed by stacking a plurality of dielectric layers 111 in the thickness direction (T-axis direction) and sintering them, and includes the plurality of dielectric layers 111, and first internal electrode layers 121 and second internal electrode layers 122 that are alternately disposed in the thickness direction (T-axis direction) with the dielectric layers 111 interposed therebetween.

In this case, adjacent dielectric layers 111 in the capacitor body 110 may be so integrated that it is difficult to see the boundaries between the dielectric layers without the use of a scanning electron microscope (SEM).

Further, the capacitor body 110 may include an active region and cover regions 112 and 113.

The active region is a portion that contributes to the formation of the capacitance of the multilayered capacitor 100. As an example, the active region may be the region where the first internal electrode layers 121 and the second internal electrode layers 122 that are stacked along the thickness direction (T-axis direction) overlap.

The cover regions 112 and 113 are margin portions in the thickness direction, and may be positioned on the first surface side and second surface side of the active region in the thickness direction (T-axis direction). These cover regions 112 and 113 may be stacked on the upper surface and lower surface of the active region, respectively, and each may consist of a single dielectric layer 111 or two or more dielectric layers 111.

Additionally, the capacitor body 110 may further include a side cover region. The side cover regions are margin portions in the width direction, and may be positioned on the fifth surface side and sixth surface side of the active region in the width direction (W-axis direction), respectively. These side cover regions may be formed by stacking dielectric green sheets with conductive paste layers for forming internal electrode layers and sintering them. When the conductive paste layers are formed on the surfaces of the dielectric green sheets, the conductive paste may be coated only on some portions of the surfaces of the dielectric green sheets and may not be coated on both side surfaces of the surfaces of the dielectric green sheets.

The cover regions 112 and 113 and the side cover regions serve to prevent damage to the first internal electrode layers 121 and the second internal electrode layers 122 by physical or chemical stress.

### Internal Electrode

The first internal electrodes 121 and the second internal electrodes 122 are electrodes with different polarities, and may be alternately arranged opposite each other along the T-axis direction with the dielectric layer 111 in between, and one end may be exposed through the third and fourth surfaces of the capacitor body 110, respectively.

The first internal electrodes 121 and the second internal electrodes 122 may be electrically insulated from each other by the dielectric layers 111 disposed therebetween.

The end portions of the first internal electrodes 121 and the second internal electrodes 122 that are alternately exposed from the third and fourth surfaces of the capacitor body 110 may be electrically coupled to the first external electrode 131 and the second external electrode 132, respectively.

The internal electrodes 121 and 122 may include zirconium (Zr) and, for example, may include a conductive metal and zirconium (Zr), or an alloy of a conductive metal and zirconium (Zr).

The zirconium (Zr) may be added to the conductive paste for an internal electrode in the form of Zr oxide (ZrO₂), and after the sinter process, the internal electrodes 121 and 122 may include Zr oxide (ZrO₂), Zr, or a combination thereof.

Because the Zr oxide (ZrO₂) has a higher melting point of about 1100° C. than a conventional co-material of barium titanite (BaTiO₃), the Zr oxide, which is included in the conductive paste for an internal electrode and sintered, exhibits superbly excellent heat shrinkage delay effect of the internal electrodes, compared with the barium titanite. Accordingly, thermal stability of the internal electrodes is increased, significantly improving the electrode connectivity of the internal electrodes. If the electrode connectivity is improved, capacitance and BDV (Break Down Voltage) of the multilayered capacitors may be increased.

For example, the conductive metal may further include a metal such as Ni, Cu, Ag, Pd, or Au, and the like or an alloy thereof, for example, an Ag—Pd alloy. For example, if the conductive metal is Ni, the first and second internal electrodes 121 and 122 may include Ni and Zr, for example, an Ni—Zr alloy.

Also, the first internal electrodes 121 and the second internal electrodes 122 may include dielectric particles of the same composition system as that of the ceramic material that is included in the dielectric layers 111.

The first internal electrodes 121 and the second internal electrodes 122 may be formed using conductive paste including a conductive metal. The printing method of the conductive paste may use a screen printing method, a gravure printing method, or the like.

In one embodiment, zirconium (Zr) has an average content of greater than or equal to about 0.0005 mol % and less than about 5.0 mol % based on the total internal electrodes 121 and 122.

For example, the average zirconium (Zr) content may be greater than or equal to about 0.0005 mol % or greater than or equal to about 0.001 mol % and less than about 5 mol %, less than or equal to about 2.5 mol %, or less than or equal to about 1.0 mol % based on the internal electrodes 121 and 122.

For example, the average zirconium (Zr) content may be about 0.0005 mol % to about 2.5 mol %, for example, about 0.001 mol % to about 2.5 mol %, or about 0.001 mol % to about 1.0 mol % based on the internal electrodes 121 and 122.

When the average zirconium (Zr) content is less than about 0.0005 mol % based on the internal electrodes 121 and 122, the electrode connectivity may not only be insignificantly improved, but also electrical characteristics and reliability of the capacitors may be deteriorated.

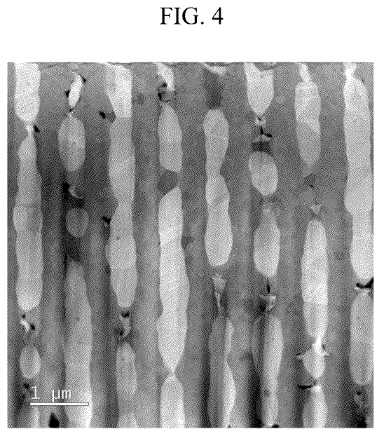

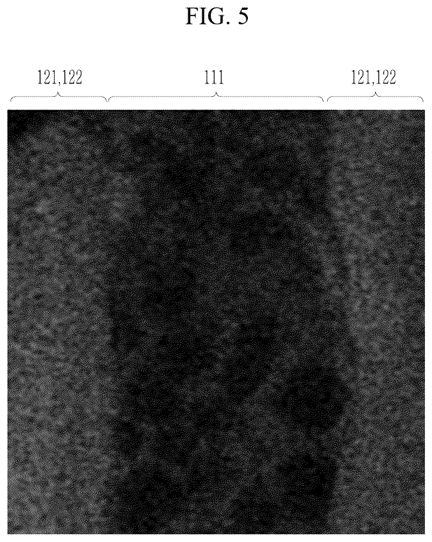

FIG. 4 is a scanning electron microscope (SEM) image of a portion of the cross section of a multilayered capacitor according to an embodiment, and FIG. 5 is an image showing a portion of the SEM image of FIG. 4 mapped for the Zr component.

Referring to FIGS. 4 and 5, the average zirconium (Zr) content (mol %) in the internal electrodes 121 and 122 may be measured in the following method.

First, the multilayered capacitor 100 is placed in an epoxy mixture and cured, and the W-axis and T-axis direction sides of the capacitor body 110 are polished to ½ the point in a L-axis direction, then placed in a vacuum atmosphere chamber, and then, cut in the W-axis direction and the T-axis direction from the center of the L-axis direction of the capacitor body 110 to prepare a cross-sectional sample (hereinafter referred to as a “cross-sectional sample”).

Subsequently, the cross-sectional sample is examined with a scanning electron microscope (SEM) or a transmission electron microscope (TEM) to obtain an SEM image or a TEM image.

For example, the SEM image shown in FIG. 4 is mapped with the Zr component, as shown in FIG. 5, to check a Zr distributions in the cross-sectional sample. In addition, a content of Zr may be obtained through SEM-EDAX or TEM-EDAX quantitative analysis.

The average Zr content included in the internal electrodes may be obtained by selecting an internal electrode located in the central portion of the cross-sectional sample, measuring the Zr content at more than 3 points of the selected internal electrode through the SEM-EDAX or TEM-EDAX quantitative analysis, and calculating their arithmetic mean.

As an example, the average thicknesses of the first internal electrodes 121 and the second internal electrodes 122 may be greater than or equal to about 0.1 μm, greater than or equal to about 0.2 μm, or greater than or equal to about 0.5 μm, and less than or equal to about 2.0 μm, less than or equal to about 1.5 μm, or less than or equal to about 1.0 μm.

The average thickness of the first internal electrode 121 or second internal electrode 122 may be measured by the following method.

It may be an arithmetic mean value of the thicknesses of the first internal electrode 121 or second internal electrode 122 at 10 points spaced at predetermined intervals from a reference point in the scanning electron microscope (SEM) of the cross-sectional sample, when the center point in the longitudinal direction (L-axis direction) or width direction (W-axis direction) of the first internal electrode 121 or second internal electrode 122 is used as a reference point.

The intervals between the 10 points may be adjusted according to the scale of the SEM image, and may be, for example, an interval of about 1 μm to about 100 μm, about 1 μm to about 50 μm, or about 1 μm to about 10 μm.

In this case, all 10 points should be located within the first internal electrode 121 or the second internal electrode layer 122, and when all 10 points are not located within the first internal electrode 121 or the second internal electrode layer 122, the position of the reference point may be changed or the interval of 10 points may be adjusted.

### Dielectric Layer

Zr oxide (ZrO₂) added to the conductive paste for internal electrodes may partially diffuse into the dielectric layer 111 in the form of Zr through the sintering process, and the diffused Zr may be mainly located in the shell of dielectric grains with a core-shell structure. Accordingly, the insulating properties of the dielectric layer increase, and the reliability of the multilayered capacitor can be significantly improved.

The dielectric layer 111 includes a plurality of dielectric grains.

The dielectric grains include a main component and a subcomponent.

The main component is a dielectric base material, has a high dielectric constant, and contributes to forming the dielectric constant of the multilayered capacitor 100.

The main component may include a dielectric material including BaₘTiO₃ (0.995≤m≤1.010), (Ba₁₋ₓCaₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x≤0.10), (Ba₁₋ₓCaₓ)ₘ(Ti_{1-y}Sn_{y})O₃ (0.995≤m≤1.010, 0≤x≤0.10, 0<y≤0.20), or a combination thereof.

For example, the main component may include (Ba₁₋ₓCaₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x≤0.10), or a combination thereof.

For example, the main component may include BaTiO₃, Ba(Ti, Zr)O₃, Ba(Ti, Sn)O₃, (Ba, Ca)TiO₃, (Ba, Ca)(Ti, Zr)O₃, (Ba, Ca)(Ti, Sn)O₃, (Ba, Sr)TiO₃, (Ba, Sr)(Ti, Zr)O₃, (Ba, Sr)(Ti, Sn)O₃, or a combination thereof.

The subcomponent may include zirconium (Zr), manganese (Mn), chromium (Cr), silicon (Si), aluminum (Al), magnesium (Mg), tin (Sn), antimony (Sb), hafnium (Hf), and germanium (Ge), gallium (Ga), indium (In), lanthanum (La), yttrium (Y), actinium (Ac), cerium (Ce), praseodymium (Pr), neodymium (Nd), promethium (Pm), samarium (Sm), europium (Eu), gadolinium (Gd), Terbium (Tb), dysprosium (Dy), holmium (Ho), erbium (Er), thulium (Tm), ytterbium (Yb), lutetium (Lu), or a combination thereof.

The dielectric layer 111 may further include a ceramic additive, an organic solvent, a binder, a dispersant, or a combination thereof.

In an embodiment, at least one of the plurality of dielectric grains may have a core-shell structure.

A dielectric grain having a core-shell structure includes a dielectric core and a shell surrounding at least a portion of the core within one dielectric grain.

The core and the shell have a different molar ratio of a subcomponent to a main component, wherein the molar ratio of a subcomponent to a main component may be, for example, sharply changed at a boundary of the core and the shell. Accordingly, the boundary of the core and the shell may be easily distinguished, which may be checked through transmission electron microscope-energy dispersive X-ray analysis (TEM-EDX).

For example, the subcomponent may not be present in the core but if any, present in a very small amount. Accordingly, the core may be composed of a pure main component alone without impurities, wherein the pure main component in general may have a higher dielectric constant than a main component doped with elements, which are the impurities. Accordingly, the core may serve to maintain the dielectric constant.

The shell may more include the subcomponent than the core. In the shell, the subcomponent doped in B-sites of the main component (perovskite ABO₃ structure) has an effect of increasing bandgap energy of diffusing other rare earth elements and doping elements into dielectric grains. Accordingly, the shell may serve as a barrier suppressing the diffusion of the other rare earth elements and the doping elements into the dielectric grains. The shell may suppress growth of the dielectric grains and thus contribute to the atomization of the dielectric grains. In addition, in the shell, the subcomponent doped in A-sites of the main component may serve to improve the reliability and the dielectric constant.

For example, the core included in one dielectric grain may have an average area of about 50% to about 90%, for example, about 60% to about 90%, or about 70% to about 90%.

For example, the shell included in one dielectric grain may have an average area of about 10% to about 50%, for example, about 10% to about 40%, or about 10% to about 30%.

In an embodiment, the core, the shell, or both include zirconium (Zr).

In an embodiment, an average content of zirconium (Zr) included in the shell for a total shell may be greater than an average content of zirconium (Zr) included in the core for a total core.

In an embodiment, an average content of zirconium (Zr) included in the shell for a total shell may be about 0.001 mol % to about 10.0 mol %, for example about 0.01 mol % to about 10.0 mol %, about 0.1 mol % to about 10.0 mol %, or about 0.1 mol % to about 5.0 mol %.

In an embodiment, an average content of zirconium (Zr) included in the core for a total core may be about 0 mol % to about 2.0 mol %, for example about 0 mol % to about 1.0 mol %, or about 0 mol % to about 0.5 mol %.

When the average content of zirconium (Zr) included in the core and shell satisfies the above numerical range, a highly reliable multilayered capacitor can be implemented.

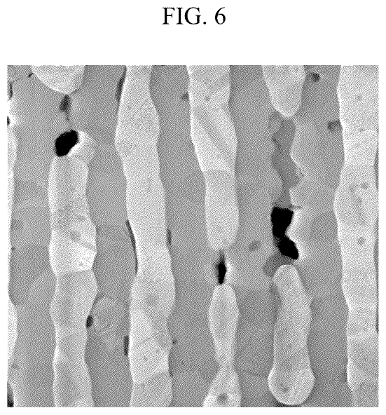

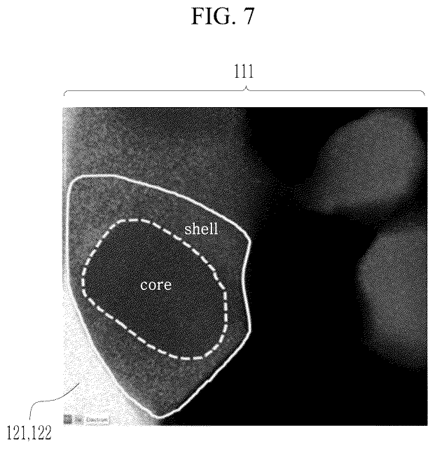

FIG. 6 is a TEM (Transmission Electron Microscope) image of a portion of the cross section of a multilayered capacitor according to an embodiment and FIG. 7 is an image showing a portion of the TEM image of FIG. 6 mapped for the Zr component.

Referring to FIGS. 6 and 7, an average zirconium (Zr) content included in the core and the shell may be measured in the following method.

In the TEM image of the cross-sectional sample, three or more dielectric grains located within about 200 nm toward the center from the interface of the internal electrode and the dielectric layer are selected. Each of the selected dielectric grains are mapped with the Zr component to distinguish a boundary between core and shell to respectively select three points from the core and shell regions. In addition, each Zr content is obtained in any selected region through SEM-EDAX or TEM-EDAX quantitative analysis and used to calculate an arithmetic mean as the average zirconium (Zr) content included in the core and the shell.

For example, an average thickness of the dielectric layer 111 may be greater than or equal to about 0.1 μm, or greater than or equal to about 0.5 μm, and less than or equal to about 5.0 μm, less than or equal to about 2.5 μm, or less than or equal to about 1.0 μm.

The average thickness of the dielectric layer 111 may be measured by the following method.

First, a scanning electron microscope (SEM) image obtained by observing a cross-sectional sample with a scanning electron microscope is prepared.

The average thickness of the dielectric layer 111 may be an arithmetic mean value of the thicknesses of the dielectric layer 111 at 10 points spaced at predetermined intervals from a reference point in the SEM image of the cross-sectional sample, when the center point in the L-axis direction or W-axis direction of the dielectric layer 111 is used as a reference point.

The intervals between the 10 points may be adjusted according to the scale of the SEM image, and may be, for example, an interval of about 1 μm to about 100 μm, about 1 μm to about 50 μm, or about 1 μm to about 10 μm.

In this case, all 10 points should be located within the dielectric layers 111, and when all 10 points are not located within the dielectric layers 111, the position of the reference point may be changed or the interval of 10 points may be adjusted.

### External Electrode

The first external electrode 131 and the second external electrode 132 are provided with voltages with different polarity and respectively connected electrically to each exposed portion of the first internal electrode 121 and the second internal electrode 122.

According to the above configuration, if a predetermined voltage is applied to the first external electrode 131 and the second external electrode 132, charges are accumulated between the first internal electrode 121 and the second internal electrode 122 facing each other. Herein, the multilayered capacitor 100 may have proportional capacitance to an area where the first internal electrode 121 and the second internal electrode 122 are overlapped each other along a T-axis direction in the active region.

The first external electrode 131 and the second external electrode 132 may be disposed on the third and fourth surfaces of the capacitor body 110, respectively, and may include first and second connection portions, respectively, that are coupled to the first internal electrodes 121 and the second internal electrodes 122, respectively, and include first and second band portions, respectively, that are disposed at the edges where the third and fourth surfaces of the capacitor body 110 meet either the first and second surfaces or the fifth and sixth surfaces.

The first and second band portions may extend from the first and second connection portions to some points of either the first and second surfaces or fifth and sixth surfaces of the capacitor body 110. The first and second band portions may serve to improve the adhesion strength of the first external electrode 131 and the second external electrode 132.

As an example, each of the first external electrode 131 and the second external electrode 132 may include a sintered metal layer that is in contact with the capacitor body 110, a conductive resin layer that is disposed to cover the sintered metal layer, and a plating layer that is disposed to cover the conductive resin layer.

The sintered metal layer may include a conductive metal and indium (In).

The sintered metal layer may include, as the conductive metal, copper (Cu), nickel (Ni), silver (Ag), palladium (Pd), gold (Au), platinum (Pt), tin (Sn), tungsten (W), titanium (Ti), lead (Pb), an alloy thereof, or a combination thereof, and for example, copper (Cu) may include a copper (Cu) alloy. For example, when the conductive metal is Cu, the sintered metal layer includes Cu and In, and for example, may include a Cu—In alloy. If the conductive metal includes copper, metals other than copper may be included in the amount of less than or equal to about 5 parts by mole based on 100 parts by mole of copper.

As an example, the sintered metal layer may further include glass. In this case, the sintered metal layer may include a composition including oxides as glass, and may include, for example, one or more selected from silicon oxides, boron oxides, aluminum oxides, transition metal oxides, alkali metal oxides, and alkaline earth metal oxides. The transition metal may be selected from zinc (Zn), titanium (Ti), copper (Cu), vanadium (V), manganese (Mn), iron (Fe), and nickel (Ni), and the alkali metal may be selected from lithium (Li), sodium (Na), and potassium (K), and the alkaline earth metal may be one or more selected from magnesium (Mg), calcium (Ca), strontium (Sr), and barium (Ba).

Optionally, the conductive resin layer is formed on the sintered metal layer, and for example, may be formed to completely cover the sintered metal layer. Meanwhile, the first external electrode 131 and the second external electrode 132 may not include a sintered metal layer, and in this case, the conductive resin layer may be in direct contact with the capacitor body 110.

The conductive resin layers may extend to the first and second surfaces or fifth and sixth surfaces of the capacitor body 110, and the lengths of regions (i.e., band portions) where the conductive resin layers extend to the first and second surfaces or fifth and sixth surfaces of the capacitor body 110 may be longer than the lengths of regions (i.e., band portions) where the sintered metal layers extend in the first and second surfaces or fifth and sixth surfaces of the capacitor body 110. In other words, the conductive resin layers may be formed on the sintered metal layers, and may be formed so as to completely cover the sintered metal layers.

The conductive resin layers include a resin and a conductive metal.

The resin which is included in the conductive resin layers is not particularly limited as long as it has a bonding property and an impact absorption property and can be mixed with conductive metal powder to form a paste, and may include, for example, a phenolic resin, an acrylic resin, a silicone resin, an epoxy resin, or a polyimide resin.

The conductive metal that is included in the conductive resin layers serves to electrically connect the conductive resin layers to the first internal electrode 121 and the second internal electrode 122, or the sintered metal layer.

The conductive metal that is included in the conductive resin layer may have a spherical shape, a flake shape, or a combination thereof. In other words, the conductive metal may be formed only in a flake shape, or may be formed only in a spherical shape, or may be the form of a mixture of a flake shape and a spherical shape.

Herein, the spherical shape may include a shape which is not completely spherical, and may include, for example, a shape in which a ratio of the length of the major axis to the length of the minor axis (major axis/minor axis) may be less than or equal to about 1.45. The flake-type powder refers to a powder with a flat and elongated shape, and is not particularly limited, but for example, a ratio of the length of the major axis to the length of the minor axis (major axis/minor axis) may be greater than or equal to about 1.95.

The first external electrode 131 and the second external electrode 132 may further include a plating layer disposed outside the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb) which may be included alone or alloys thereof. As an example, each plating layer may be a nickel (Ni) plating layer or a tin (Sn) plating layer, or may be a form in which a nickel (Ni) plating layer and a tin (Sn) plating layer are sequentially stacked, or may be a form in which a tin (Sn) plating layer, a nickel (Ni) plating layer, and a tin (Sn) plating layer are sequentially stacked. Alternatively, each plating layer may include a plurality of nickel (Ni) plating layers and/or a plurality of tin (Sn) plating layers.

The plating layer can improve mountability to the substrate, structural reliability, durability to the outside, heat resistance, and equivalent series resistance (ESR) of the multilayered capacitor 100.

### Method of Manufacturing Multilayered Capacitor

A method of manufacturing the multilayered capacitor according to another embodiment includes manufacturing a capacitor body including a dielectric layer and an internal electrode and then, forming an external electrode on the outside of the capacitor body.

First, the manufacturing the capacitor body is illustrated.

In the manufacturing process of the capacitor body, a dielectric paste, which will be formed into a dielectric layer after sintering, and a conductive paste, which will be formed into an internal electrode after the sintering, are prepared.

The dielectric paste is, for example, prepared in the following method. Dielectric powders are uniformly mixed through wet mixing and the like, dried, and heat-treated under predetermined conditions obtain plasticized powder. Subsequently, an organic vehicle or an aqueous vehicle is added to the plasticized powder and additionally, kneaded to prepare the dielectric paste.

The obtained dielectric paste is formed into a dielectric green sheet by using a technique such as the doctor blade method. Additionally, the dielectric paste may include additives selected from various dispersants, plasticizers, dielectrics, subcomponent compounds, or glass, if necessary.

The conductive paste for internal electrodes is prepared by kneading a conductive powder made of a conductive metal or an alloy thereof with a binder or solvent. As an example, the conductive paste for internal electrodes can be prepared by kneading zirconium oxide. The conductive paste for internal electrodes may include ceramic powder (for example, barium titanate powder) as a co-material, if necessary. The co-material may act to suppress sintering of the conductive powder during the sintering process.

The conductive paste for an internal electrode is coated with a predetermined pattern on the dielectric green sheet surface in various printing methods such as screen printing or transfer methods, etc. Subsequently, the dielectric green sheets with the internal electrode pattern in plural are stacked and then, pressed in a stacking direction to obtain a dielectric green sheet laminate. Herein, the internal electrode patterns may be stacked so that the dielectric green sheet laminate may have a dielectric green sheet at the top and at the bottom in the stacking direction.

Optionally, the obtained dielectric green sheet laminate may be cut into a predetermined size by dicing or the like.

In addition, the dielectric green sheet laminate, if necessary, may be solidified and dried to remove the plasticizer and the like and then, barrel-polished by using a horizontal centrifugal barrel machine, etc. In the barrel-polishing, unnecessary parts such as burrs, etc., which are generated during the cutting, may be polished by inserting the dielectric green sheet laminate with media and a polishing solution into a barrel container and then, applying rotational motion, vibration, or the like to the barrel container. In addition, after the barrel-polishing, the dielectric green sheet laminate may be washed with a cleaning solution such as water and the like and dried.

The dielectric green sheet laminate is subjected to binder removal and sintering treatments to obtain a capacitor body.

The binder removal treatment is performed under conditions appropriately adjusted according to a main component composition of the dielectric layer and a main component composition of the internal electrode. For example, the binder removal treatment is performed by increasing a temperature at about 5° C./hour to about 300° C./hour and maintained at a support temperature of about 180° C. to about 400° C. for about 0.5 hour to about 24 hours. The binder removal is performed under an air or reducing atmosphere.

The sintering treatment may be performed under conditions appropriately adjusted according to a main component composition of the dielectric layer or a main component composition of the internal electrode. For example, the sintering treatment may be performed at about 1200° C. to about 1350° C. or about 1220° C. to about 1300° C. for about 0.5 hour to about 8 hours or about 1 hour to about 3 hours. The sintering treatment is performed under a reducing atmosphere, for example, under an atmosphere in which a mixed gas of nitrogen gas (N₂) and hydrogen gas (H₂) is humidified. When the internal electrode includes nickel (Ni) or a nickel (Ni) alloy, the oxygen partial pressure in the sintering atmosphere may be about 1.0×10⁻¹⁴ MPa to about 1.0×10⁻¹⁰ MPa.

After the sintering treatment, annealing may be performed. Because the annealing is a treatment to reoxidize the dielectric layer, if the sintering is performed under the reducing atmosphere, the annealing may be performed. The annealing treatment is performed under conditions appropriately adjusted according to a main component composition of the dielectric layer and the like. For example, the annealing treatment may be performed at about 950° C. to about 1150° C. for about 0 hour to about 20 hours at about 50° C./hour to about 500° C./hour. In addition, the annealing may be performed under a humidified nitrogen gas (N₂) atmosphere at an oxygen partial pressure of about 1.0×10⁻⁹ MPa to about 1.0×10⁻⁵ MPa.

The humidifying nitrogen gas, mixed gas, or the like in the binder removal treatment, the sintering treatment, or the annealing treatment may be performed, for example, by using a wetter and the like, wherein a temperature of water used therein may be at about 5° C. to about 75° C. The binder removal treatment, the sintering treatment, and the annealing treatment may be performed sequentially or independently.

Optionally, the third and fourth surfaces of the capacitor body may be subjected to surface treatment such as sand blasting, laser irradiation, or barrel polishing. This surface treatment may expose ends of the first and second internal electrodes onto the outermost surfaces of the third and fourth surfaces, which may solidify electrical bonding between the first and second external electrodes and the first and second internal electrodes and easily forming alloy portions.

Subsequently, a paste for forming a sintered metal layer is coated on the outside of the obtained capacitor body and sintered to form sintered metal layers as the external electrodes.

The paste for forming a sintered metal layer may include a conductive metal and glass. The conductive metal and the glass are the same as aforementioned above and thus will not be repetitively mentioned. In addition, the paste for forming a sintered metal layer may optionally include a subcomponent such as a binder, solvent, dispersant, plasticizer, or oxide powder. For example, the binder may be ethylcellulose, acrylic, or butyral, and the solvent may be an organic solvent such as terpineol, butyl carbitol, alcohol, methyl ethyl ketone, acetone, or toluene, or an aqueous solvent.

A method of coating the paste for forming a sintered metal layer on the outside of the capacitor body may include dipping, various printings such as screen printing and the like, coating by using a dispenser, etc., or spraying using a spray, and the like. The paste for forming a sintered metal layer is coated at least on the third and fourth surfaces of the capacitor body and optionally, each portion of the first surface, the second surface, the fifth surface, or the sixth surface where band portions of the first and second external electrodes are formed.

Subsequently, the capacitor body, which is coated with the paste for forming a sintered metal layer, is dried and sintered at about 700° C. to about 1000° C. for about 0.1 hour to about 3 hours to form the sintered metal layers.

Optionally, on the outside of the obtained capacitor body, a paste for forming a conductive resin layer is coated and cured to form a conductive resin layer.

The paste for forming the conductive resin layer may include a resin and, optionally, a conductive metal or a non-conductive filler. Because the descriptions of the conductive metal and resin are the same as described above, repetitive description will be omitted. Additionally, the paste for forming the conductive resin layer may optionally include a subcomponent such as a binder, solvent, dispersant, plasticizer, or oxide powder. For example, the binder may be ethylcellulose, acrylic, or butyral, and the solvent may be an organic solvent such as terpineol, butyl carbitol, alcohol, methyl ethyl ketone, acetone, or toluene, or an aqueous solvent.

For example, a method of forming the conductive resin layer may include dipping the capacitor body 110 in the paste for forming a conductive resin layer and curing it, or printing the paste for forming a conductive resin layer on the surface of the capacitor body 110 in screen printing, gravure printing, etc. or coating and coating the paste for forming a conductive resin layer on the surface of the capacitor body 110 and then, curing it.

Subsequently, the plating layer is formed on the outside of the conductive resin layer.

For example, the plating layer may be formed in a plating method, for example, by sputtering or electric deposition.

Hereinafter, specific examples of the invention will be presented. However, the following examples are intended only to specifically illustrate or describe the invention, and should not be construed as limiting the scope of the invention.

### EXAMPLES

### Example 1

A dielectric green sheet is prepared by preparing dielectric slurry including BaTiO₃ and then, coating the dielectric slurry with a head discharge-type on-roll coater.

Subsequently, a conductive paste for an internal electrode is prepared by weighing and mixing Ni and Zr, so that a content of Zr may be 0.001 mol % based on a total amount of internal electrodes.

The conductive paste is printed on the surface of the dielectric green sheet, and the dielectric green sheets (width×length×height=3.2 mm×2.5 mm×2.5 mm) with the conductive paste layer are in plural stacked and compressed to manufacture a dielectric green sheet laminate.

The dielectric green sheet laminate is plasticized at 400° C. or less under a nitrogen atmosphere and sintered at 1300° C. or less at a hydrogen (H₂) concentration of 1.0% or less to manufacture a multilayered capacitor according to Example 1.

### Examples 2 to 3 and Comparative Examples 1 to 3

Multilayered capacitors of Examples 2 to 3 and Comparative Examples 1 to 3 are manufactured in the same manner as in Example 1 except that the content of Zr based on the total amount of internal electrodes is adjusted as shown in Table 1.

### Evaluation Examples

### Evaluation Example 1: Evaluation of Electrode Connectivity

The multilayered capacitors of Examples 1 to 3 and Comparative Examples 1 to 3 are evaluated with respect to electrode connectivity.

First, four multilayered capacitors are prepared, placed in an in an epoxy mixture and cured, then the W-axis direction and T-axis direction sides of the capacitor body 110 are polished to ½ point in the L-axis direction, then placed in a vacuum atmosphere chamber, and then, cut in the W-axis direction and the T-axis direction from the center of the L-axis direction of the capacitor body 110 to prepare cross-sectional samples (hereinafter referred to as “cross-sectional samples”). Subsequently, the cross-sectional samples are examined with a transmission electron microscope (TEM) (at 200× magnification) to prepare TEM images.

After selecting any internal electrode therefrom and drawing an imaginary line in a L-axis direction thereon, a ratio of an unbroken length of the internal electrode to a total length of the internal electrode is calculated.

A length ratio of Comparative Example 1 is set as a reference value of 1 to calculate each relative length ratio the other examples and comparative examples.

### Evaluation Example 2: Evaluation of Electrical Characteristics (BDV, Capacitance), Reliability (MTTF)

The multilayered capacitors of Examples 1 to 3 and Comparative Examples 1 to 3 are evaluated with respect to a breakdown voltage (BDV), capacitance, and MTTF, and the results are shown in Table 2.

BDV is measured by preparing each multilayered capacitor by 50, applying a voltage thereto from 0 V to 1100 V by 1.00000 V in a Sweep method with Keithely 2410, and measuring a voltage where a current reaches 20 mA as the breakdown voltage. The breakdown voltage is measured in a silicone oil bath. BDV of Comparative Example 1 is used as a reference value of 1 to calculate each relative value of the other examples and the comparative examples.

The capacitance is measured by using an LCR meter under conditions of 1 kHZ and AC 0.5 V, and capacitance of Comparative Example 1 is used as a reference value 1 to calculate each relative value of the other examples and the comparative examples, which are shown in Table 2.

MTTF (Mean Time To Failure) is measured by performing a high temperature load test on 400 samples per the examples and the comparative examples under conditions of 125° C. and 8 V. Herein, MTTF (Mean Time To Failure) is when insulation resistance reaches 10 kΩ or less, and MTTF of Comparative Example 1 is used as a reference value of 1 to calculate each relative value of the other examples and the comparative examples, which are shown in Table 2.

TABLE 1

| | Zr content | Electrode | | | |
|---|---|---|---|---|---|
| | (mol %) | connectivity | Capacitance | BDV | MTTF |
| Comparative | 0.00 | 1 (reference) | 1 (reference) | 1 (reference) | 1 (reference) |
| Example. 1 | | | | | |
| Example. 1 | 0.001 | 1.03 | 1.07 | 1.01 | 1.05 |
| Example. 2 | 0.1 | 1.07 | 1.15 | 1.06 | 1.14 |
| Example 3 | 1 | 1.05 | 1.09 | 1.17 | 1.22 |
| Comparative | 5 | 0.98 | 0.93 | 1.08 | 1.16 |
| Example. 2 | | | | | |
| Comparative | 10 | 0.87 | 0.80 | 0.94 | 0.91 |
| Example. 3 | | | | | |

Referring to Table 1, in Examples 1 to 3, as a Zr content in internal electrodes increases from 0.001 mol % to 1 mol %, electrode connectivity increases due to an internal electrode shrinkage delay effect, and accordingly, capacitance increases.

However, Comparative Example 2, in which an excessive amount of Zr is diffused into a dielectric layer and causes a side effect to a dielectric, exhibits deteriorated electrode connectivity and capacitance, compared with Comparative Example 1.

In addition, Examples 1 to 3 exhibit increased BDV (Break Down Voltage) and MTTF (reliability) due to increased interface reliability between dielectric layer and internal electrodes.

However, Comparative Example 3, in which Zr is excessively included, exhibits deteriorated BDV and MTTF, compared with Comparative Example 1.

While this invention has been described in connection with what is presently considered to be practical exemplary embodiments, it is to be understood that the invention is not limited to the disclosed exemplary embodiments. On the contrary, it is intended to cover various modifications and equivalent arrangements included within the spirit and scope of the appended claims.

### DESCRIPTION OF SYMBOLS

100: multilayered capacitor
110: capacitor body
111: dielectric layer
112, 113: cover region
121: first internal electrode
122: second internal electrode
131: first external electrode
132: second external electrode

What is claimed is:

1. A multilayered capacitor, comprising
a capacitor body including a dielectric layer and an internal electrode; and
an external electrode outside the capacitor body,
wherein the internal electrode includes zirconium (Zr),
an average content of zirconium (Zr) for the internal electrode is greater than or equal to about 0.0005 mol % and less than about 5.0 mol %,
the dielectric layer includes a plurality of dielectric grains,
at least one of the plurality of dielectric grains has a core-shell structure, and
the core, the shell, or both include zirconium (Zr).

2. The multilayered capacitor of claim 1, wherein
the internal electrode further includes a conductive metal.

3. The multilayered capacitor of claim 1, wherein
the dielectric grain includes a main component and a subcomponent, and
the main component includes BaₘTiO₃ (0.995≤m≤1.010), (Ba₁₋ₓCaₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x≤0.10), (Ba₁₋ₓCaₓ)ₘ(Ti_{1-y}Sn_{y})O₃ (0.995≤m≤1.010, 0≤x≤0.10, 0<y≤0.20), or a combination thereof.

4. The multilayered capacitor of claim 3, wherein
the subcomponent includes zirconium (Zr), manganese (Mn), chromium (Cr), silicon (Si), aluminum (Al), magnesium (Mg), tin (Sn), antimony (Sb), hafnium (Hf), and germanium (Ge), gallium (Ga), indium (In), lanthanum (La), yttrium (Y), actinium (Ac), cerium (Ce), praseodymium (Pr), neodymium (Nd), promethium (Pm), samarium (Sm), europium (Eu), gadolinium (Gd), Terbium (Tb), dysprosium (Dy), holmium (Ho), erbium (Er), thulium (Tm), ytterbium (Yb), lutetium (Lu), or a combination thereof.

5. The multilayered capacitor of claim 1, wherein
an average content of zirconium (Zr) for the internal electrode is in a range from about 0.001 mol % to about 1.0 mol %.

6. The multilayered capacitor of claim 1, wherein
An average content of zirconium (Zr) included in entirety of the shell is greater than an average content of zirconium (Zr) included in entirety of the core for a total core.

7. The multilayered capacitor of claim 1, wherein
an average content of zirconium (Zr) included in entirety of the shell is in a range from about 0.001 mol % to about 10.0 mol %.

8. The multilayered capacitor of claim 1, wherein
an average content of zirconium (Zr) included in entirety of the core is in a range from about 0 mol % to about 2.0 mol %.

9. The multilayered capacitor of claim 1, wherein
an average thickness of the dielectric layer is in a range from about 0.1 μm to about 5 μm.

10. The multilayered capacitor of claim 1, wherein
an average thickness of the internal electrode is in a range from about 0.1 μm to about 2 μm.

11. A multilayered capacitor, comprising
a capacitor body including a dielectric layer and an internal electrode, and
an external electrode outside the capacitor body,
wherein the internal electrode includes a conductive metal and zirconium (Zr),
the dielectric layer includes a plurality of dielectric grains,
at least one of the plurality of dielectric grains has a core-shell structure,
the core, the shell, or both include zirconium (Zr),
an average content of Zr in the core is less than about 1 mol %, and
an average content of Zr in the shell is in a range from about 0.001 mol % to about 10 mol %.

12. The multilayered capacitor of claim 11, wherein
the dielectric grain includes a main component and a subcomponent, and
the main component includes BaₘTiO₃ (0.995≤m≤1.010), (Ba₁₋ₓCaₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x≤0.10), (Ba₁₋ₓCaₓ)ₘ(Ti_{1-y}Sn_{y})O₃ (0.995≤m≤1.010, 0≤x≤0.10, 0<y≤0.20), or a combination thereof.

13. The multilayered capacitor of claim 12, wherein
the subcomponent includes zirconium (Zr), manganese (Mn), chromium (Cr), silicon (Si), aluminum (Al), magnesium (Mg), tin (Sn), antimony (Sb), hafnium (Hf), and germanium (Ge), gallium (Ga), indium (In), lanthanum (La), yttrium (Y), actinium (Ac), cerium (Ce), praseodymium (Pr), neodymium (Nd), promethium (Pm), samarium (Sm), europium (Eu), gadolinium (Gd), Terbium (Tb), dysprosium (Dy), holmium (Ho), erbium (Er), thulium (Tm), ytterbium (Yb), lutetium (Lu), or a combination thereof.

14. The multilayered capacitor of claim 11, wherein
an average content of zirconium (Zr) for the internal electrode is in a range from about 0.0005 mol % to about 5.0 mol %.

15. The multilayered capacitor of claim 11, wherein
an average content of zirconium (Zr) included in entirety of the shell is greater than an average content of zirconium (Zr) included in entirety of the core.

16. The multilayered capacitor of claim 11, wherein
an average content of zirconium (Zr) for the internal electrode is in a range from about 0.001 mol % to about 1.0 mol %.

17. The multilayered capacitor of claim 11, wherein
an average thickness of the dielectric layer is in a range from about 0.1 μm to about 5 μm.

18. The multilayered capacitor of claim 11, wherein
an average thickness of the internal electrode is in a range from about 0.1 μm to about 2 μm.

19. A multilayered capacitor, comprising:
an internal electrode comprising zirconium (Zr) and a conductive metal, wherein an average content of Zr in the internal electrode is in a range from about 0.0005 mol % to about 5.0 mol %; and
a dielectric layer comprising at least one dielectric grain having a core-shell structure, wherein core of the core-shell structure has an average Zr content of less than 1 mol %, and shell of the core-shell structure has an average Zr content in a range from about 0.001 mol % to about 10 mol %.
